(19) United States
(12) Patent Application Publication
(10) Pub. No.: US 2011/0238544 A1
(43) Pub. Date: Sep. 29, 2011

(54) Method and system for managing interactive communications campaigns with proactive payments

(76) Inventor: Timothy R. Segall, Lexington, MA (US)

(21) Appl. No.: 12/731,681

(22) Filed: Mar. 25, 2010

(51) Int. Cl. G06Q 30/00; G06Q 20/00; G06Q 40/00

(52) U.S. Cl. 705/34; 705/40

(57) ABSTRACT

A messaging platform includes a messaging subsystem that provides client-configurable proactive payment function. During a given interactive communications campaign, this function proactively contacts each of a set of target customers about a future (upcoming) payment amount and deadline (e.g., a minimum credit card payment, a monthly committed payment, or the like) and attempts to facilitate a “proactive payment” event associated with that payment.

### BACKGROUND

1. Technical Field

This disclosure relates generally to a method and system for managing interactive communication campaigns over a computer network, such as the Internet.

2. Description of the Related Art

It is known to provide a web-based hosted solution through which business entities create and manage interactive or notification communications campaigns. An example of an interactive communications campaign is a telephone campaign to determine whether a target recipient desires to transfer a credit card balance to a new account, a campaign to remind a recipient that a credit card payment is due and to offer the recipient an opportunity to speak with a customer representative concerning any payment issues, or the like. The hosted solution typically is implemented as an application (or “managed”) service provider. One or more business entities (“clients”) that desire to use the service typically register and access the service through an on-line (e.g., web-based) portal. In one representative use scenario, the managed service provider entity provides outbound telemarketing services on behalf of participating clients. The campaign typically is provisioned by the client. Thus, for example, using a web-based interface, a participating client defines a script for the campaign, imports a set of contacts, and defines one or more parameters that govern how the campaign is to be run. At a designated time, the service provider initiates the campaign, e.g., by providing the contacts to a set of telephone servers that set-up and manage the telephone calls to the targets of the campaign. During a given outbound voice call, as noted above, a recipient (a “customer”) may be afforded an option to connect to a contact center, e.g., to speak to a customer representative. In such implementations, the hosted solution typically is integrated directly with the contact center's on-premises automatic call distributor (ACD).

A known use case for the platform is payment notification, by which customers are notified about upcoming or past due payments.

### BRIEF SUMMARY

A messaging platform includes a messaging subsystem that provides client-configurable proactive payment function. During a given interactive communications campaign, this function proactively contacts each of a set of target customers about a future (upcoming) payment amount and deadline (e.g., a minimum credit card payment, a monthly committed payment, or the like) and attempts to facilitate a “proactive payment” event associated with that payment.

In a representative embodiment, the system is configured (by the client) with a list of target customers, such as those customers having payments coming due to the client, e.g., within the next 24-48 hours. Using opt-in (or previously-supplied opt-in data), the service initiates outbound contacts (e.g., via voice, text or email) to the target customers. A target customer is one who has opted-in or will opt-in in the proactive payments service. That service provides for expedited remittance of a given payment (or portion thereof) so as to avoid delinquency, in exchange for a convenience fee. The particular manner and mode of the contacts are determined by a set of preferences. These preferences may be varied for each client, and they comprise a campaign strategy and/or a set of associated business rules for proactive communication. Upon right party verification (RPV) of the customer, the system identifies the amount of the upcoming payment and prompts the customer to authorize the proactive payment.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a block diagram of a service provider infrastructure for implementing a managed communications campaign service;

FIGS. 2A-2B illustrates how an interactive communications campaign is created and managed in the service provider infrastructure illustrated in FIG. 1;

FIG. 3 illustrates an auto-payment sub-system for use in the service provider infrastructure to provide payment notifications and to facilitate customer payments;

FIG. 4 illustrates a representative platform-customer interaction using the auto-payment sub-system;

FIG. 5 illustrates a representative customer interaction during the proactive payments operation using a voice channel; and

FIG. 6 illustrates a representative customer interaction during the proactive payments operation using a text channel.

### DETAILED DESCRIPTION

FIG. 1 illustrates a representative service provider or system architecture, which in the preferred embodiment is implemented in or across one or more data centers. A data center typically has connectivity to the Internet. The system provides a web-based hosted solution through which business entities create and manage communications campaigns. Campaigns may be interactive or non-interactive. Representative campaigns include, without limitation, account renewal campaigns, balance transfer or consolidation offer campaigns, billing issue campaigns, credit card activation campaigns, fraud alert campaigns, payment or past due reminder campaigns, customer survey campaigns, debt recovery campaigns, late payment with right party verification campaigns, payment reminder with direct connect to contact center campaigns, appointment reminder campaigns, welcome campaigns, account renewal campaigns, affinity cross-sell/rewards program campaigns, crisis management/disaster recovery campaigns, new product offer campaigns, inquiry/web follow-up campaigns, contract renewal campaigns, service availability notification campaigns, promotional offer campaigns, service delivery confirmation campaigns, and the like. The particular type of campaign is not a limitation or feature of the invention.

A business entity (a “client”) user has a machine such as a workstation or notebook computer. Typically, a business entity user accesses the service provider architecture by opening a web browser on the machine to a URL associated with a service provider domain. Access may also be through an automated process, such as via a Web services application programming interface (API). Where a web browser is used, the client authenticates to the managed service in the usual manner, e.g., by entry of a username and password. The connection between the business entity machine and the service provider infrastructure may be encrypted or otherwise secure, e.g., via SSL, or the like. Although connectivity via the publicly-routed Internet is typical, the business entity may connect to the service provider infrastructure over any local area, wide area, wireless, wired, private or other dedicated network. As seen in FIG. 1, the service provider architecture 100 comprises an IP switch 102, a set of one or more web server machines 104, a set of one more application server machines 106, a database management system 108, a set of SMS message servers 109, and a set of one or more telephony server machines 110. A representative web server machine 104 comprises commodity hardware (e.g., Intel-based), an operating system such as Linux, and a web server such as Apache 2.x. A representative application server machine 106 comprises commodity hardware, Linux, and an application server such as WebLogic 10.3 (or later). The database management system 108 may be implemented as an Oracle (or equivalent) database management package running on Linux. A representative telephony server machine is an application server that implements appropriate software applications for call set-up, voice processing, and other call connection and management activities. An application may implement the Media Resource Control Protocol (MRCP). In the alternative, a telephony server machine may execute an application server in conjunction with one or more PSTN, VoIP and/or voice processing cards that provide interconnectivity for telephone-based calling applications. In a card-based embodiment, a representative card is a CG 6565 (or variant) series available from Dialogic, or an equivalent. Typically, a voice processing application port or card has a finite number of supported ports. In a high volume call environment, there may be several web server machines, several application server machines, and a large number of telephony server machines. Although not shown in detail, the infrastructure may include a name service, FTP servers, MRCP (Media Resource Control Protocol) servers, load balancing appliances, other switches, and the like. Each machine typically comprises sufficient disk and memory, as well as input and output devices. The software environment on each machine includes a Java virtual machine (JVM) if control programs are written in Java. Generally, the web servers 104 handle incoming business entity provisioning requests, and they export a management interface that is described in more detail below. The application servers 106 manage the basic functions of generating campaign scripts, managing contacts, and executing campaigns. As will be discussed below, the campaign may provide end users voice messages, text messages, email messages, or combinations thereof. For voice messaging, the telephony servers 110 handle most telephony-related functions including, without limitation, executing outbound calls and forwarding calls to a contact center. The particular hardware and software implementation details described herein are merely for illustrative purposes are not meant to limit the scope of the present invention.

In a representative embodiment, a typical machine in the service infrastructure is a processor-based server running Linux, and the server includes a telephone interface. A typical interface has up to 240 ports, and each port may be considered a separate telephone line. There are typically a set of such servers operating at a given location (e.g., an Internet data center). The following is a typical operation of the voice messaging service. Using a Web browser or the Web service API, a client provisions a campaign, provisioning a script to be played to a target customer. The scope and content of the script will depend on the campaign. The client also provides the service provider with contact information for a set of persons, who are the target recipients of the campaign. In operation, the system batches a subset of those contacts to one of the machines in the server farm. A control routine executing on the machine takes a first contact in the subset and assigns the contact to an available port. The script is then initiated and the interface card initiates a call over a port. When the recipient's phone is answered, the system determines whether a human being has answered the call (as opposed to an answering machine, a fax, or the like). If a human being has answered, the script plays a set of prompts (basically a set of scripted questions). During the call, if the target recipient takes a given action, a direct-connect (DC) function is initiated. In particular, the system places the call on hold, opens up a separate line to a contact center telephone number (typically provisioned by the client), waits for an agent to respond, places the responding agent on hold, and then bridges the customer to the agent. The system then disconnects. In an alternative, the DC function may take place whether or not the recipient actively initiates it, e.g., by just having the system inform the recipient to “please hold” while the connection to the contact center is established by the service provider.

The contact center may be owned, operated or managed by a third party. The service provider may manage the agents directly. A representative contact center includes automatic call distribution (ACD) functions. As is well-known, an ACD is a computer-implemented and controlled telephone system that distributes calls to contact center agents equitably and gathers statistics about the agents. When the service provider controls and/or manages the agents directly, the provider infrastructure may include a dialer, which is an automatic telephone dialing system. A dialer initiates outbound call from a list of telephone numbers, turns a call over to an agent when a human being responds, and gathers statistics about agents. Such ACD and dialer technologies are well-known.

Using the service provider infrastructure, a business entity can create, execute and manage a message (voice, text, email, or combination) campaign. As noted above, a campaign may have associated therewith one or more “sub-campaigns.” Using a Web interface, a client loads a list of contacts who will be called and associates that list with a script. A “sub-campaign” refers to one or more passes through a contact list that has been bound to a script and that has been associated with a given timeframe. Thus, a “sub-campaign” associates at least the following items: a list of contacts, a script, and a timeframe. Additional details regarding sub-campaigns are set forth below. As noted above, a script determines what will happen during a contact (e.g., an outbound voice call). Typically, a script is formatted as XML and (in a voice message scenario) specifies a sequence of audio prompts that are played and what happens when the recipient takes certain actions such as pressing a button on the phone or speaking a response. As noted above, a direct-connect to the contact center may be carried out automatically (merely when the system determines that the call has been answered by other than an answering machine) and thus the script may designate this functionality.

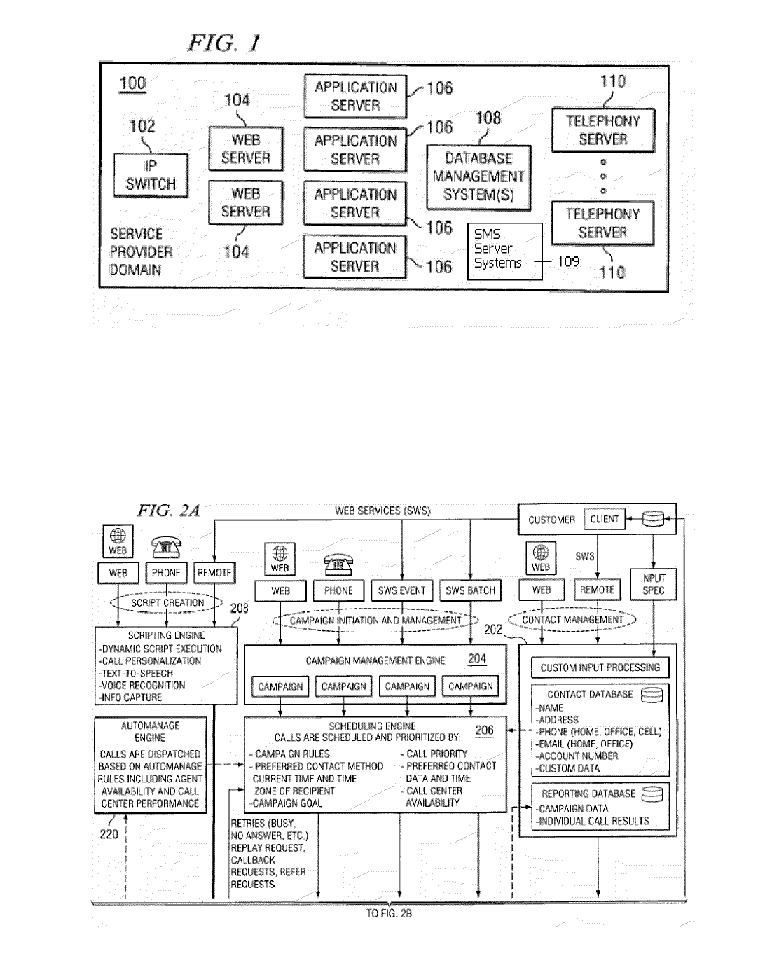

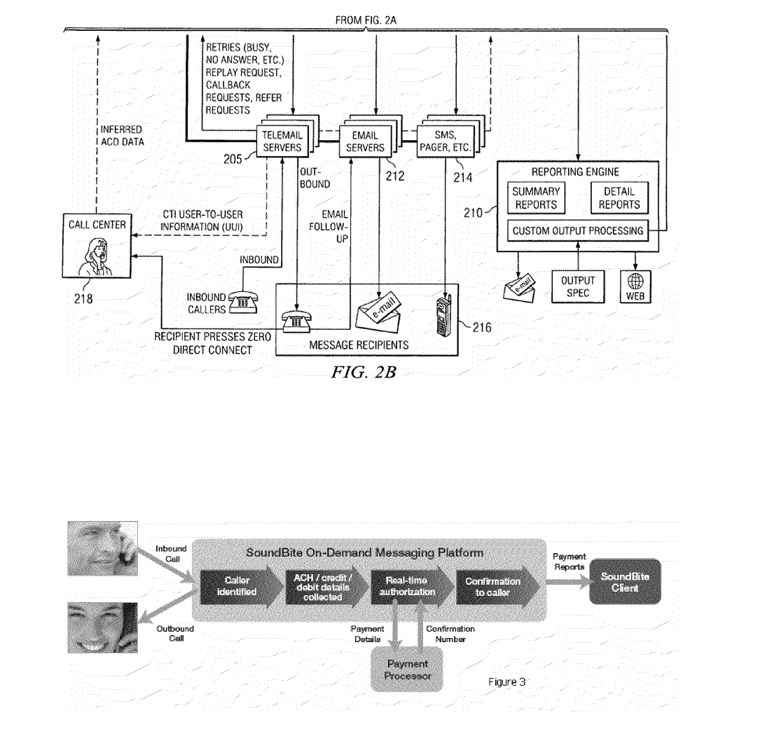

One or more contact lists are stored in a contact database, and typically a contact list comprises a set of contacts. A contact typically is an individual in the contact database, and this individual is sometimes referred to as the “customer” (as, technically, the individual is a customer of the client using the managed service). A contact can include home, work or cell numbers, a client identifier, an email address, or the like. Also, contacts typically include first name, last name, company and other information. With reference to FIGS. 2A-2B, and as described above, a business entity connects to the service provider, authenticates, and then uses one or more applications to create, execute and manage the campaign. These applications execute on the application server machines and operate in association with one or more databases that are supported within the database management system. These applications include, for example, a contact management application 202, a campaign management engine 204, a scheduling engine 206, and a scripting engine 208. The contact management application 202 handles the receipt and storage of the contact list(s) uploaded (e.g., via FTP or otherwise) to the system by or on behalf of the business entity client. The scripting engine 208 handles the creation and managing of the campaign scripts, using instructions entered by or on behalf of the business entity client via a web-based interface or Web services API. The campaign management engine 204 manages the campaign by interoperating with the scheduling engine 206, which in turn interoperates with the telephony servers 205 to execute the campaign. The business entity client evaluates or monitors the campaign from summary, detail and/or custom reports generated by a reporting engine application 210. Campaign evaluation and monitoring may also be performed via a Web-based user interface, or in an automated manner via an API. Notification campaigns are executed using email servers 212 and SMS (or MMS) servers 214, or by other means, such as by telephone.

As also illustrated in FIGS. 2A-2B, after connecting an outbound call to a target customer 216, the customer may elect to be connected to the contact center 218 (typically a third party contact center) or the system may perform that direct-connect automatically once it determines that a human being (as opposed to an answering machine) has answered the outbound call. (An end user may also send a message (e.g., an SMS) to the system). The system typically obtains information about the contact center's performance during a given communications campaign, commonly without requiring a direct connection between the infrastructure and a contact center's on-premises ACD. This enables the managed service provider to integrate with both its business entity clients and with their associated contact center environments rapidly and efficiently. The interconnectivity between the managed service provider and the contact center may be “inferred” from how calls that originate from the service provider to the target recipients (who have expressed an interest in being connected to the contact center) are actually handled. This “indirect” connectivity is illustrated in FIG. 2 by the control engine 220, which can be provided in software as a set of software instructions executable on a processor. In the voice messaging scenario, the engine is responsible for dispatching messages at an appropriate rate while ensuring that all customer-requested rule parameters (as described below) are honored. Examples of such parameters include: number of agents available at the contact center, maximum hold time at the contact center, client abandon rate prior to speaking to a contact center, number of bad numbers reached on the outbound dial, and so forth. Generally, for a given client campaign or sub-campaign, the engine 220 decides on an initial message dispatch rate based on the client-requested parameters (and, optionally, on historical data from like campaigns or sub-campaigns). Once the campaign or sub-campaign, as the case may be, starts running, the engine 220 monitors the parameters and ensures that they remain within tolerance. If an identified parameter exceeds the client-defined value, then a system action rule (e.g., adjusting the message dispatch rate, suspending the sub-campaign, or the like) is applied and any client notification requested is issued. Additional details regarding the functionality of the engine 220 are described in U.S. Publication No. 2007/0172050, which is commonly-owned.

As noted above, preferably a web-based interface is provided to enable a business entity client to create a set of one or more management rules that, when triggered during the campaign, cause the infrastructure (and, in particular, certain control applications therein) to take certain control actions in real-time, preferably based on campaign performance. A campaign may include several preset strategies that a client may choose to change based on day of week or time of day.

As used herein, the following terms have the associated meanings. As noted above, a “campaign” refers to an overall series of messages to a contact list using one or more sub-campaigns that use a given script. Campaigns also act as templates for the sub-campaigns that are created under them. A campaign typically has a preset configuration that applies to all of its sub-campaigns. As noted above, a “sub-campaign” refers to one or more passes through a contact list using a script and that is constrained to a particular timeframe (or at a set of one or more such times). A sub-campaign typically runs under an existing campaign. A “script” as noted above determines what happens during a customer interaction (e.g., a phone call for a voice campaign). Commonly, the script specifies (for a voice call) a sequence of audio prompts that are played to a client (an end user who receives a call) and what happens (the contact center connection) when the recipient takes certain actions (such as pressing a button on the phone or speaking an answer to a query). The script may also specify other actions, such as effecting a contact center connection automatically when detecting that a human being has answered. The nature and type of actions set forth in a script thus may be quite varied, and this disclosure is not limited to any particular process flow within a script.

An “agent” typically is a contact center operator. A “skill group” is a set of agents that are trained to handle a given script. In one embodiment, a skill group defines the number of agents who are scheduled to be on duty at various times of the day on various days of the week, as well as the phone number to use to contact those agents. A skill group can be shared across multiple sub-campaigns or over multiple physical facilities (e.g., telephone numbers). A script may cause the routing of direct-connect calls to different skill groups based on the path through the script. A client of the service may assign a skill group to a sub-campaign when it creates the sub-campaign, whereupon the agents in that skill group are then responsible for handling any incoming messages for that sub-campaign. Agents in a skill group become “live” according to a schedule or upon login to the service provider. Thus, in one embodiment a “live” agent is an agent that has been registered with the service provider, e.g., using a supervisor dashboard or a contact center schedule. An “unallocated” agent is an agent that is not yet allocated to a sub-campaign. An “allocated” agent is an agent that is allocated to a sub-campaign. A “busy” agent is an agent currently assisting a client. An “available” agent is an agent waiting for work. A “break” is a state when the agent is away from his or her station. The acronym “ACW” refers to “after-call-work” or agent processing, which occurs after a particular customer service is completed and before the agent is servicing a new customer contact.

In one embodiment, agents in a skill group may be automatically allocated to a particular sub-campaign based on a priority of each running sub-campaign. This is not a requirement, however. Thus, for example, sub-campaigns with a higher priority are given as many agents as they can use before a lower-priority sub-campaign is considered. Sub-campaigns of equal priority are allocated agents according to a number of agents that can be used (or the number of available contacts) in a next time period (e.g., 5 minutes). In the alternative, such prioritization of sub-campaigns need not be enforced across agents in a skill group, thereby enabling more equal access to the agents. The agents allocated to each sub-campaign typically changes over time as the number of available contacts changes (which affects the number of agents that can be used by each sub-campaign). Preferably, the system adjusts the rate for a sub-campaign based on several factors: the number of agents currently being used by the sub-campaign, the percentage of attempts that result in a direct connect attempt, and an average length of a successful direct connect call.

As noted above, agent allocation is not a requirement. In the alternative, agents in a skill group are either taking a call or are idle. They may receive a call from any sub-campaign currently assigned to the skill group. In this embodiment, a priority value determines if a particular sub-campaign should be dialed at a faster rate than another. This results in one sub-campaign generating more direct-connects and requiring more agents from the pool of available agents.

Typically, a skill group is based on one or more business requirements. For example, skill groups may be based on skill type, language skills, skill level, or other such factors. When a new sub-campaign is created, a skill group is assigned to that sub-campaign. The schedule for the skill group then determines the messaging rate at any given time. As more agents come on duty, typically the rate increases to keep those agents busy. When fewer agents are on duty, however, the rate decreases to avoid long hold queues for the customers. As noted above, a single skill group can be assigned to multiple sub-campaigns at the same time. Messages from each sub-campaign preferably are sent to any available agent in the skill group, so a given agent should be trained to handle messages from each of the sub-campaigns.

There may be different types of skill groups, such as a standard skill group, and an enhanced agent mode skill group. The standard skill group typically is a skill group to which a single phone number is assigned, and that number is a default phone number when there is no other number defined in the script. A standard skill group typically does not use a service-side hold queue, as defined below. With a standard skill group, agents always hang up after the client call has completed. Caller ID can be used to generate an agent screen pop-up window with the correct customer information if the client's infrastructure supports the capability. As an alternative, an audible “whisper” with customer information can be played for the agent prior to completing the connection. Agents may take advantage of a service-side hold queue to “stay-on-line” (remain connected and to receive a next customer after the last customer hangs-up, as described in more detail below). If agents remain connected, caller ID typically is not used for the screen pop-up because, typically, caller ID cannot be changed after the first call the agent's phone has been placed. If the enhanced agent mode skill group mode is used, contacts connect directly to a specific agent who has his or her own unique telephone number. Thus, when this type of skill group is configured, individual agents are added (by name) together with the associated telephone numbers. In this configuration, each agent has a unique phone number, or each agent may be set up with a different extension where one or more agents share the unique phone number. As with the standard mode configuration, agent mode skill groups use a pre-defined schedule. Individual agents, however, can each have a custom schedule or can participate in a common schedule group. The service provider can track individual agent activity in this mode, and agents use the hold queue and can stay-on-line as described above. In this mode, caller ID is not used for an agent screen pop-up window.

The system preferably executes a program to provide an agent “portal” by which an administrator (e.g., a supervisor) can administer and manage agents. The portal typically includes an agent screen, and a supervisor screen. A server component executes in the service provider system infrastructure, and a client component executes in the agent's desktop, preferably in a web browser. When the system is operating in the enhanced agent mode skill group configuration, the status of the individual agents can be viewed. This view contains information, such as the client contact with whom the agent is being connected. In this embodiment, a web page can be used as a screen pop to pass information to the agent about the contact. Typically, an agent operating in this mode has the following mutable attributes: skill group, telephone number, sub-campaign, and state (e.g., unallocated, available, busy, ACW, handoff, break, hold queue, or unavailable). The agent also can be visualized from the perspective of his or her identity, authentication information, permissions and access rights. Preferably, upon connection to the service provider or the appropriate contact center system, the agent's screen is refreshed periodically (e.g., once per second). The server-client screen pop functionality may be implemented in any convenient manner using existing technologies such as Comet, AJAX, XMPP, and the like. Comet is a WWW architecture in which a web server sends data to a client program (normally a web browser) asynchronously without any need for the client to explicitly request it. This allows for the creation of an event-driven web application. XMPP refers to eXtensible Messaging and Presence Protocol (f/k/a Jabber), which is an open, XML-based protocol for near real-time, extensible instant messaging (IM) and presence information (a/k/a buddy lists). XMPP is extensible and can support other features such as voice over IP (VoIP) and file transfer. In a representative embodiment, an agent has a telephony connection and an associated machine (e.g., a desktop computer, a laptop computer or other mobile computing device, or the like) that comprises a web browser or other rendering engine that is compatible with AJAX technologies (e.g., XHTML, XML, CSS, DOM, JSON, and the like). AJAX technologies include XHTML (Extensible HTML) and CSS (Cascading Style Sheets) for marking up and styling information, the use of DOM (Document Object Model) accessed with client-side scripting languages, the use of an XMLHttpRequest object (an API used by a scripting language) to transfer XML and other text data asynchronously to and from a server using HTTP), and use of XML or JSON (Javascript Object Notation, a lightweight data interchange format) as a format to transfer data between the server and the client.

The following describes a typical life cycle for an un-owned agent. Once an agent enters the live state, he or she is typically unallocated. Once the agent is allocated to a specific sub-campaign, he or she enters an available state. The system then establishes and maintains the persistent telephony connection to the agent, as previously described. Once a customer request occurs (a client has requested a direct-connect), the agent enters various states, such as busy. After the call is completed, the agent enters (or may enter) the ACW state, after which the agent transitions back to the available state where he or she can receive a next call.

### Payment Subsystem

The platform includes an auto-payment interface that allows service provider scripts to collect payments from customers and to process those payments, preferably in real-time. The subsystem enables the service provider to seamlessly integrate fully-automated inbound and outbound contacts (e.g., by voice, text, e-mail or the like) with one or more third party payment processing platforms.

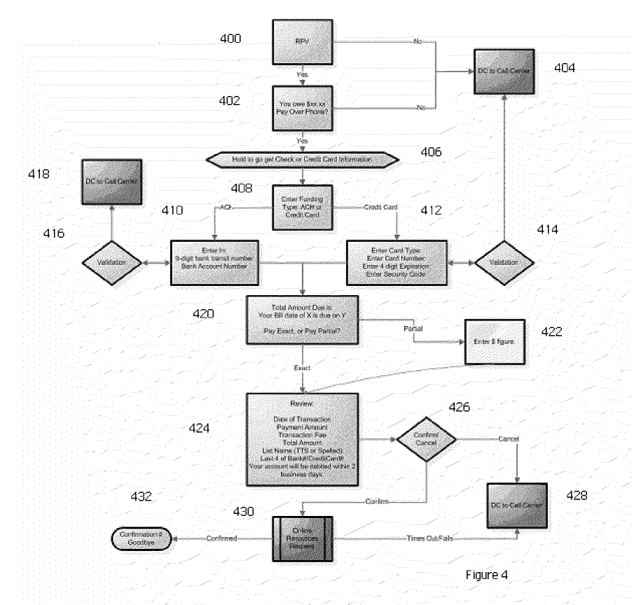

The basic operation of the payment subsystem is illustrated in FIG. 3. A collect script is created, preferably using one or more existing script templates. Once the collect script is created, a contact list is loaded into the system. The client sets-up a new sub-campaign to call the list using the script in the manner described above. Once the sub-campaign is initiated, the system attempts to reach each contact on the list at a scheduled time as dictated by a customer or client preference. Once the customer is right party verified, the system conducts an automated interactive dialog with the customer. For those customers that choose to make a payment, the service provider collects credit card, debit card or other (e.g., ACH) details, and then submits them to a particular payment processor. Preferably, these details are submitted to the processor in real-time, with the communication link between the platform and the contact persisted. The script receives a response code back from the payment processor indicating whether the transaction succeeded, which allows the script to notify the contact of the transaction result. The service delivers a report to the client containing the details of each outbound contact and each transaction processed, including whether each transaction succeeded or failed, and a transaction ID for each transaction attempt. The entire process can be automated.

FIG. 4 is a process flow diagram illustrating the operation of the payment subsystem for a typical customer interaction. This process flow assumes that the outbound contact has been established and the system has initiated right party verification (RPV) 400. If RPV is not successful, the routine branches to direct connect to the contact center. This is step 404. If RPV is successful, the routine continues at step 402 to play a recording indicating the amount of the upcoming payment. If the customer elects not to provide the payment, control may branch once again to the contact center as indicated. At step 406, the system enters a hold to enable the customer to obtain the check or credit card information. At step 408, the customer enters (e.g., via DTMF, speech, text, or the like) the funding type (e.g. ACH, credit card, etc.). If a checking account will be used, the routine branches to step 410 during which the customer is prompted to enter in his or her bank's transit number and their personal bank account number. The checking account information is attempted to be validated at step 416 and, failing validation, the customer is direct-connected to the contact center. If a card will be used, the routine branches to step 412 to receive the card number and associated security code. The card information is attempted to be validated at step 414 and, failing validation, the customer is direct-connected to the contact center. Upon a successful ACH or card validation, the customer is notified of the “Total Amount Due” and the associated “Bill date of X is due on Y.” The customer also is prompted whether he or she wants to pay the exact amount due or a partial payment. If a partial payment is selected, the routine branches to step 422 to receive the amount of the partial payment. At step 424, the platform reviews the transaction and, at step 426, requests confirmation by the customer that he or she still desires to proceed. If not, the pending transaction is cancelled and the customer is direct-connected to the contact center. This is step 428. If the customer confirms his or her desire to continue, the routine branches to step 430, which begins the interaction with the payment processor. The connection between the platform and the customer is maintained while the platform undertakes to obtain an approval from the payment processor. Once that approval is received (by way of a response code), the platform provides to the customer a confirmation number (possibly via an alternate channel, such as text), and then terminates the interaction. This is step 432. If, however, the platform cannot complete its separate interaction with the payment processor within a given timeout period, or if the transaction is denied by the processor, the routine direct-connects the customer to the contact center. This completes the processing. The client script that continues the sub-campaign, using a next contact identified in the contact list.

In an alternative embodiment, the payment subsystem already possesses/stores a payment credential from the customer, and this credential is passed to the payment processor so that the customer does not need to enter the checking account or card information.

The above-identified technique is enhanced by providing a proactive payment option. This option assumes that the customer has enrolled in the proactive payments service, and such enrollment may be carried out in any convenient manner, such as via an on-line web site enrollment, using an IVR, via e-mail, by submitting a remittance stub, or the like. The proactive payments service associated with a particular client may include one or more proactive payment preferences as defined in a campaign strategy. Typically, a campaign strategy is associated with a script and includes one or more of the following: campaign level filtering; pass pattern; namely, escalation type (none, contact-based, call pass-based and intra-pass device escalation), and number and type of passes (voice, text or email). Each pass itself can include components such as: pass level list filtering, contact accept criteria, delivery timeframe, delivery options, and re-try options. Escalation types dictate how the system should escalate with re-tries within each pass. A user can choose one of the following: no escalation type, contact based escalation, call pass-based escalation, intra-pass device escalation, or the like.

When proactive payments is enabled, the customer is afforded an option to make an expedited payment, in exchange for a given convenience fee as defined in the proactive payments service offering, to ensure that the payment is timely received by the payment processor. Thus, this type of solution will be most useful for customers who cannot make immediate (e.g., credit card) payments but who, instead, must rely on checking or other payment methods that typically take several days to clear. These customers are then contacted proactively a short time before their payments would otherwise be due so that they can be offered an opportunity to use the proactive payments option and thereby avoid a delinquency. Using proactive payments, the customer is prompted to have the platform facilitate a proactive payment (in exchange for the convenience fee) so that the delinquency can be avoided. The convenience fee may be paid in whole or in part to the service provider for providing the service interaction.

When proactive payments in implemented, the contact list provided by the client is a special list, in that it only includes those customers whose required payments have not been received within a given time period (e.g., within 24-48 hours of the previously-defined due date(s)). The system then begins the sub-campaign with respect to each contact on that list. As noted above, typically the customer would have already signed up for the proactive payments option, or he/she may be prompted to do so during the interaction (such as the interaction described above with respect to FIG. 4). The customer is then contacted, and the script might then proceed as follows (© Soundbite 2010):

“Hello, this is a Proactive Payment prompt from ABC Financial as requested by <TTS of first name> <TTS of last name>.

If this is <TTS of first name> <TTS of last name> please say or press 1 now.

If this person cannot be reached at this number, say or press 2.

To place this call on hold say or press 4 at any time.

<Voice over ‘one’>

Your payment is due today in the amount of <TTS amount>. If your payment is not received today, you will be subject to a late fee of <TTS amount>. Because you are enrolled in the Proactive Payments service, you can expedite payment now for a convenience fee of only $4.95 and avoid any late fees. To make a payment now please say or press 1. If you have already sent a payment, say or press 2. To place this call on hold, say or press 4 at any time.

<Voice over ‘one’>

Thank you. For your safety, please enter your zip code to authorize payment from the checking account you registered ending in <TTS acct number, last four>. To specify another account say or press 5.

<Voice over ‘94070’>

You have authorized a bill payment of <TTS amount> and a convenience fee of <TTN fee> from your checking account ending in <TTS acct number, last four>. To make this payment now, say or press 1. To change the amount or cancel say or press 2.

<Voice over ‘one’>

A <text message and/or email> confirming your payment will be sent momentarily, standard carrier rates may apply. Thank you for using Proactive Payments, prompting you before its due!

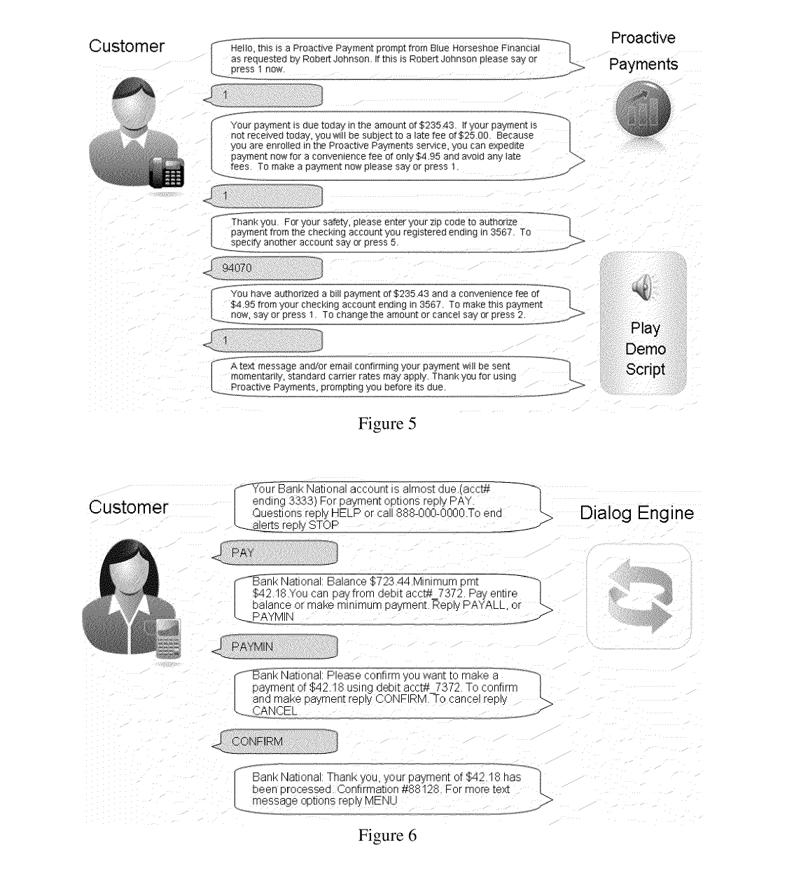

The above interaction is merely representative, and each client may design a custom interaction to suit its particular business needs/rules. FIG. 5 illustrates a representative proactive payment dialog implemented according to the above script and using the voice channel. FIG. 6 illustrates an alternative customer interaction using text-based messaging.

The convenience fee may be implemented in several ways. In a first model (a “non-absorbed” version), the fee is absorbed by the customer, and not by the biller. In this case, the biller may be charged a fee (by the platform service provider) for telephony and text messaging volume. In a second model (an “absorbed” version), the payment fee is absorbed by the biller and the customer pays no incremental cost for the service, although there may be standard per message charges (in the text-based messaging implementation)

The proactive payments service provides significant advantages. The benefits to billers (clients) are optimization (reducing cost of doing business through call deflection and pre-enrollment in low cost payment type), expansion (enhanced customer service and relationship building), innovation (creating new lines of business with revenue contribution) and ease of implementation (no barriers to entry because the service is offering in a hosted manner by the service provider). The benefits to the biller's customers are convenience (consumers can use the channel and location of choice), savings (consumers save on late fees and avoid service interruption) and control (consumers have more options and can control their payments).

During the proactive payments exchange, the service provider preferably submits, clears and settles the payment and fees, all the while keeping the customer “on the line” to ensure that the expedited remittance transaction is completed successfully. At the close of the sub-campaign, the service provider provides a remittance posting file to the client (the biller) with details of each transaction. The convenience fees may be the subject of a revenue share between the service provider and the client.

The amount of the convenience fee may be varied depending on the amount of time remaining between the notification (and proactive payment request) and the customer's actual payment deadline. Thus, a customer may be required to pay a higher convenience fee the closer to that deadline.

As previously noted, the hardware and software systems in which the subject matter herein is illustrated are merely representative. The described functionality may be practiced, typically in software, on one or more machines. Generalizing, a machine typically comprises commodity hardware and software, storage (e.g., disks, disk arrays, and the like) and memory (RAM, ROM, and the like). The particular machines used in the network are not a limitation. A given machine includes network interfaces and software to connect the machine to a network in the usual manner. As illustrated in FIG. 1, the subject disclosure may be implemented as a managed service (e.g., in an ASP model) using the illustrated set of machines, which are connected or connectable to one or more networks. More generally, the service is provided by an operator using a set of one or more computing-related entities (systems, machines, processes, programs, libraries, functions, or the like) that together facilitate or provide the inventive functionality described above. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, .ASP), and a set of applications or processes (e.g., Java applets or servlets, linkable libraries, native code, or the like, depending on platform), that provide the functionality of a given system or subsystem. As described, the service may be implemented in a standalone server, or across a distributed set of machines. Typically, a server connects to the publicly-routable Internet, a corporate intranet, a private network, or any combination thereof, depending on the desired implementation environment.

Having described our invention, what we now claim is set forth below:

1. A computer program product in a computer readable medium for use in a data processing system for managing interactive communications campaigns, wherein a given campaign comprises one or more sub-campaigns, the computer program product holding computer program instructions which when executed by the data processing system perform a method, the method comprising:
receiving from a client a list of customers, wherein each customer on the list has enrolled in an expedited remittance service, each of the customers on the list having a payment coming due to the client on a payment due date;
for each customer on the list of customers, executing an outbound contact at a given time prior to the payment due date;
during an interactive exchange with the customer as a result of the outbound contact succeeding, receiving a request by the customer to initiate an expedited remittance with the client in exchange for a service fee; and
while the interactive exchange with the customer remains active, initiating a remittance transaction in response to the request.

2. The method as described in claim 1 wherein during the interactive exchange the customer is notified of the amount of the payment and the payment due date.

3. The method as described in claim 1 wherein the given time is no more than 24-48 hours before the payment due date.

4. The method as described in claim 1 wherein an amount of the service fee is a function of the given time.

5. The method as described in claim 1 wherein the outbound contact is associated with an escalation type.

6. The method as described in claim 1 wherein the outbound contact is associated with a given contact type.

7. The method as described in claim 6 wherein the given contact type is one of: voice, text, e-mail, AVM, or a combination thereof.

8. The method as described in claim 1 further including revenue sharing the convenience fee.

9. An apparatus for managing interactive text-based communications campaigns within a data processing system, wherein a given campaign comprises one or more sub-campaigns, the apparatus comprising:
a processor;
a computer memory holding computer program instructions which when executed by the processor perform a method comprising:
receiving from a client a list of customers, wherein each customer on the list has enrolled in an expedited remittance service, each of the customers on the list having a payment coming due to the client on a payment due date;
for each customer on the list of customers, executing an outbound contact at a given time prior to the payment due date;
during an interactive exchange with the customer as a result of the outbound contact succeeding, receiving a request by the customer to initiate an expedited remittance with the client in exchange for a service fee; and
while the interactive exchange with the customer remains active, initiating a remittance transaction in response to the request.
